(19) United States
(12) Patent Application Publication
(10) Pub. No.: US 2012/0050241 A1
(43) Pub. Date: Mar. 1, 2012

(54) DISPLAY PANEL

(76) Inventors: Chun-Hao Huang, Hsin-Chu (TW); Chung-Hung Peng, Hsin-Chu (TW)

(21) Appl. No.: 13/086,384

(22) Filed: Apr. 13, 2011

(30) Foreign Application Priority Data
Aug. 26, 2010 (TW) 099128620

(51) Int. Cl. G09G 3/36; G09G 5/00

(52) U.S. Cl. 345/206; 345/87

(57) ABSTRACT

A display panel includes a first substrate, a second substrate, a display media layer, a signal transferring structure, a passivation layer and a sealant. The first substrate includes an active region and a peripheral region. The peripheral region includes a driving circuit region, and the driving circuit region includes a signal transferring region. The second substrate and the first substrate are disposed oppositely. The display media layer is disposed between the first substrate and the second substrate. The signal transferring structure is disposed in the signal transferring region of the first substrate. The passivation layer is disposed on the first substrate, and the passivation layer entirely covers at least the signal transferring structure. The sealant is disposed on the passivation layer for bonding the first substrate and the second substrate together.

### BACKGROUND OF THE INVENTION

1. Field of the Invention

The present invention relates to a display panel, and more particularly, to a display panel with a driving circuit region in which a signal transferring structure is entirely covered by a passivation layer.

2. Description of the Prior Art

Because of certain advantages, such as light weight, low volume, low power consumption, and radiation-free characteristics, liquid crystal display panels are widely used in electronic devices, such as flat panel TVs, laptop PCs, and PDAs. The liquid crystal display panel has replaced the cathode ray tube (CRT) display to become a mainstream product in the display market.

However, because conductive lines and driving circuits are disposed in peripheral regions of the conventional liquid crystal display panel, distribution of sealant used for bonding an array substrate and a color filter substrate together is constrained in many sides. Particularly when a conductive sealant is employed, distribution of the conductive sealant is constrained more severely, and designers face greater difficulties in designing a narrow border for the liquid crystal display panel.

### SUMMARY OF THE INVENTION

It is one of the objectives of the present invention to provide a display panel with narrow border design and low power consumption.

According to a preferred embodiment of the present invention, a display panel comprises: a first substrate, a second substrate, a display media layer, a signal transferring structure, a passivation layer, and a sealant. The first substrate comprises an active region and a peripheral region. The peripheral region comprises a driving circuit region, and the driving circuit region comprises a signal transferring region. The second substrate is disposed oppositely to the first substrate. The display media layer is disposed between the first substrate and the second substrate. The signal transferring structure is disposed in the signal transferring region of the first substrate. The passivation layer is disposed on the first substrate and the passivation layer entirely covers at least the signal transferring structure. The sealant is disposed on the passivation layer in the peripheral region, for bonding the first substrate and the second substrate together.

According to another preferred embodiment of the present invention, a display panel comprises: a first substrate, a second substrate, a display media layer, a signal transferring structure, a passivation layer, and a sealant. The first substrate comprises an active region and a peripheral region. The peripheral region comprises a driving circuit region, and the driving circuit region comprises a signal transferring region. The second substrate is disposed oppositely to the first substrate. The display media layer is disposed between the first substrate and the second substrate. The signal transferring structure is disposed in the signal transferring region of the first substrate. The signal transferring structure comprises a first conductive layer, an insulating layer, and a second conductive layer. The insulating layer is disposed on the first conductive layer and the insulating layer comprises at least a via hole to expose a part of the first conductive layer. The second conductive layer is disposed on the insulating layer and electrically connected to the first conductive layer through the via hole. The passivation layer is disposed on the first substrate and the passivation layer entirely covers at least the signal transferring structure. The sealant is disposed on the passivation layer in the peripheral region, for bonding the first substrate and the second substrate together.

In the present invention, because the passivation layer of the display panel entirely covers the signal transferring structure, and the passivation layer can further entirely cover the driving circuit, the allocation design of the sealant will not be constrained by the signal transferring structure and the driving circuit. The allocation design of the sealant can be modified as much as needed in the peripheral region of the first substrate, and the narrow border design can be then achieved by effectively reducing the area of the peripheral region.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-3 are schematic diagrams illustrating the display panel according to the first preferred embodiment of the present invention.

FIG. 4 is a schematic diagram illustrating a cross-sectional view of the display panel according to the second preferred embodiment of the present invention.

FIG. 5 is a schematic diagram illustrating a cross-sectional view of the display panel according to the third preferred embodiment of the present invention.

FIG. 6 is a schematic diagram illustrating a cross-sectional view of the display panel according to the fourth preferred embodiment of the present invention.

FIG. 7 is a schematic diagram illustrating a cross-sectional view of the display panel according to the fifth preferred embodiment of the present invention.

FIG. 8 is a schematic diagram illustrating a cross-sectional view of the display panel according to the sixth preferred embodiment of the present invention.

FIG. 9 is a schematic diagram illustrating a cross-sectional view of the display panel according to the seventh preferred embodiment of the present invention.

### DETAILED DESCRIPTION

To provide a better understanding of the present invention to users skilled in the technology of the present invention, preferred embodiments will be detailed as follows. The preferred embodiments of the present invention are illustrated in the accompanying drawings with numbered elements to elaborate the contents and effects to be achieved.

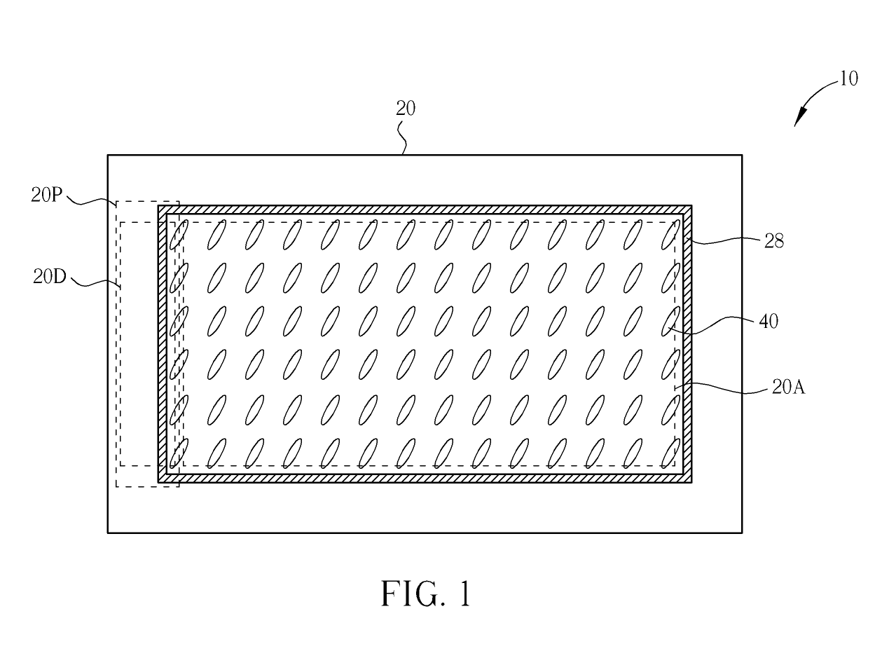

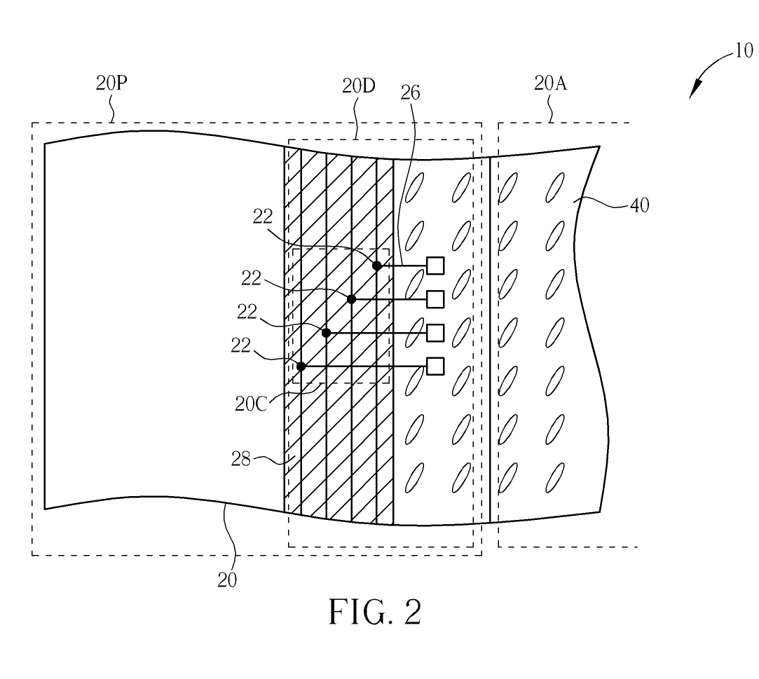

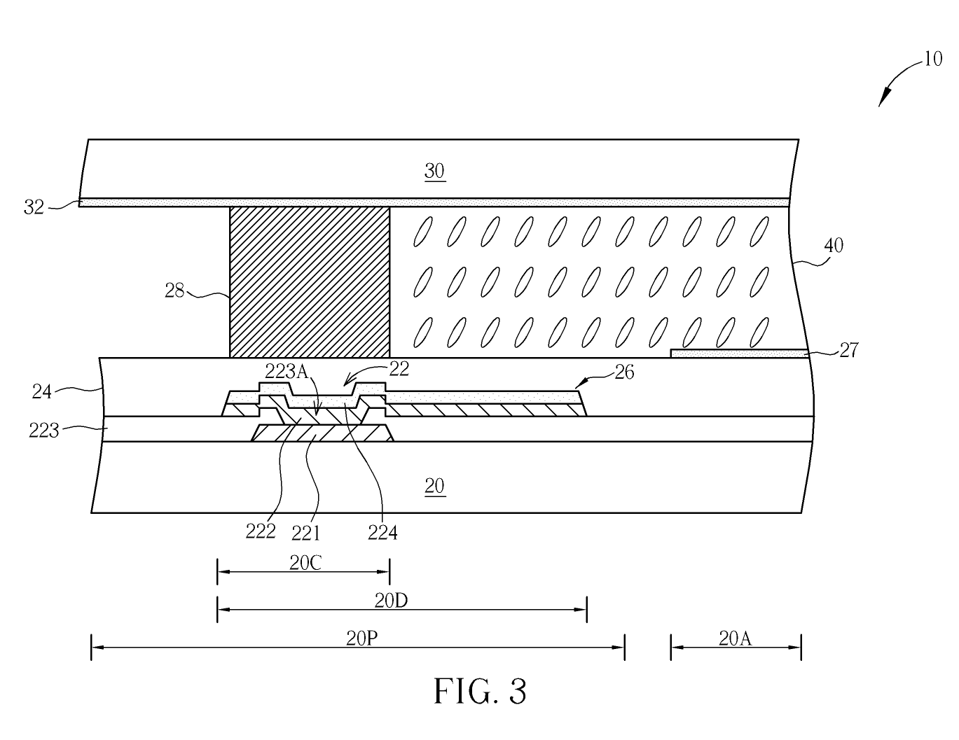

Please refer to FIGS. 1-3. FIGS. 1-3 are schematic diagrams illustrating a display panel according to a first preferred embodiment of the present invention, of which FIG. 1 is a schematic diagram illustrating a top view of the display panel, FIG. 2 is a schematic diagram illustrating a sectional view of the display panel, and FIG. 3 is a schematic diagram illustrating a cross-sectional view of the display panel. In this embodiment, the display panel 10 is a liquid crystal display panel, but the present invention is not limited to this. For clearly showing the characteristics of the display panel in this embodiment, some devices, such as the second substrate and the display media layer, are not illustrated in FIG. 1 and FIG. 2. As shown in FIGS. 1-3, the display panel 10 in this embodiment comprises a first substrate 20, a second substrate 30 (not shown in FIG. 1 and FIG. 2), a display media layer 40, a signal transferring structure 22, a passivation layer 24 (not shown in FIG. 1 and FIG. 2), and a sealant 28. The first substrate 20 may be an array substrate (also called a thin film transistor substrate), and the first substrate 20 may comprise essential devices (not shown) of the display panel 10, such as a gate line, a data line, a thin film transistor, a common line, and pixel electrodes 27. The first substrate 20 comprises an active region (also called a display region) 20A and a peripheral region 20P. The peripheral region further comprises a driving circuit region 20D, and the driving circuit region 20D comprises a signal transferring region 20C. The second substrate 30 may be a color filter substrate (also known as a counter substrate), and the second substrate 30 is disposed oppositely to the first substrate 20. The second substrate 30 may comprise a color filter layer (not shown), a common electrode 32, an alignment layer (not shown), and other essential devices of the display panel 10. The display media layer 40 may be a liquid crystal layer, and the display media layer 40 is disposed between the first substrate 20 and the second substrate 30. The signal transferring structure 22 is disposed in the signal transferring region 20C of the first substrate 20. The passivation layer 24 is disposed on the first substrate 20, and the passivation layer 24 entirely covers at least the signal transferring structure 22. The passivation layer 24 may include an inorganic passivation layer, an organic passivation layer, and an organic-inorganic composite-layered passivation layer. An alignment layer (not shown) may further be disposed on the passivation layer 24. The sealant 28 is disposed on the passivation layer 24 in the peripheral region 20P of the first substrate 20, for bonding the first substrate 20 and the second substrate 30 together. In this embodiment, the sealant 28 is a conductive sealant, such as glue mixed with Au balls, but the present invention is not limited to this. In addition to bonding the first substrate 20 and the second substrate 30 together, the conductive sealant may also be used to electrically connect the common line (not shown) disposed on the first substrate 20 to the common electrode 32 disposed on the second substrate 30. Additionally, the display media layer 40 has a first dielectric constant, the sealant 28 has a second dielectric constant, and the second dielectric constant is less than the first dielectric constant. For example, the first dielectric constant of the display media layer 40 is substantially greater than 5, and the preferred value of the first dielectric constant is substantially between 7 and 10, but the present invention is not limited to this. The second dielectric constant of the sealant 28 is substantially less than 5, and the preferred value of the second dielectric constant is substantially between 3 and 5, but the present invention is not limited to this.

In this embodiment, a driving circuit 26, such as a gate driver on array (GOA) circuit, is disposed in the driving circuit region 20D, but the present invention is not limited to this. The signal transferring structure 22 in the driving circuit 26 is used to transfer signals between conductive lines in different layers. For example, as shown in FIG. 3, the signal transferring structure 22 may comprise a first conductive layer 221, an insulating layer 223, and a second conductive layer 222. The first conductive layer 221 may be used as a first metal layer (Metal 1) for gate lines, the insulating layer 223 may be used as a gate insulating layer, and the second conductive layer 222 may be used as a second metal layer (Metal 2) for data lines, but the present invention is not limited to this. The insulating layer 223 is disposed on the first conductive layer 221, and the insulating layer 223 comprises at least a via hole 223A to expose a part of the first conductive layer 221. The second conductive layer 222 overlaps the first conductive layer 221, and more specifically, the second conductive layer 222 is disposed on the insulating layer 223 and electrically connected to the first conductive layer 221 through the via hole 223A of the insulating layer 223. In addition, the signal transferring structure 22 may selectively further comprise a transparent conductive layer 224 overlapping the second conductive layer 222 and electrically connected to the second conductive layer 222.

In this embodiment, the passivation layer 24 entirely covers at least the signal transferring structure 22. In other words, a top surface and side surfaces of the signal transferring structure 22 are entirely covered by the passivation layer 24 to insulate the signal transferring structure 22 from the outside. Additionally, the passivation layer 24 is disposed at least in the signal transferring region 20C, but the present invention is not limited to this. For example, the passivation layer 24 may further cover the driving circuit region 20D of the first substrate 20, or cover the peripheral region 20P of the first substrate 20. Because the signal transferring structure 22 and the driving circuit 26 under the passivation layer 24 may be entirely covered by the passivation layer 24, the passivation layer 24 may effectively insulate the driving circuit 26 and the signal transferring structure 22, and keep the driving circuit 26 and the signal transferring structure 22 from causing a short circuit with the sealant 28 disposed over the passivation layer 24, even if the sealant 28 is a conductive sealant. Accordingly, the position of the sealant 28 does not have to be staggered with the position of the signal transferring structure 22 and the position of the driving circuit 26. In other words, the position of the sealant 28 may overlap the position of the signal transferring structure 22 and the position of the driving circuit 26 in a vertical direction, and the area of the peripheral region 20P in the first substrate 20 may then be reduced.

For example, in this embodiment, the sealant 28 is disposed on the passivation layer 24 and corresponding to the signal transferring structure 22. The display media layer 40 is surrounded by the sealant 28 and disposed between the first substrate 20 and the second substrate 30. The display media layer 40 corresponds to the active region 20A and the peripheral region 20P inside the sealant 28. In this situation, the sealant 28 overlaps the signal transferring structure 22 in the vertical direction, and the area of the peripheral region 20P in the first substrate 20 may be reduced. In addition, it is worth noting that when the material between the signal transferring structure 22 of the first substrate 20 and the common electrode 32 of the second substrate 30 is the sealant 28, the coupling capacitance between the signal transferring structure 22 and the common electrode 32 is lower than the coupling capacitance between the signal transferring structure 22 and the common electrode 32 while the material between the signal transferring structure 22 and the common electrode 32 is the media display layer 40, because the second dielectric constant of the sealant 28 is less than the first dielectric constant of the display media layer 40. In other words, the power consumption may be reduced when the material between the signal transferring structure 22 of the first substrate 20 and the common electrode 32 of the second substrate 30 is the sealant 28.

In other embodiments of the present invention, the position of the sealant 28 is not limited to the above-mentioned embodiment, and the position of the sealant 28 may be modified according to different demands. The following description will detail the different embodiments of the display panel in the present invention, and to simplify the description, the following description will detail the dissimilarities among different embodiments without repeating description of identical components.

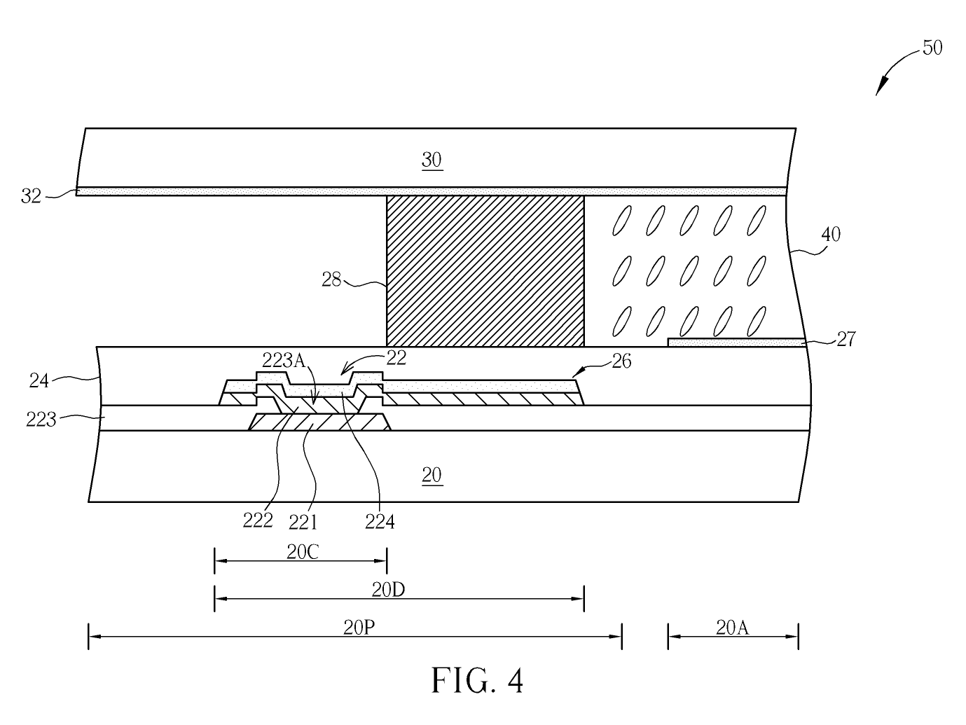

Please refer to FIG. 4. FIG. 4 is a schematic diagram illustrating a cross-sectional view of a display panel according to a second preferred embodiment of the present invention. As shown in FIG. 4, in this embodiment, the sealant 28 of the display panel 50 is disposed on the passivation layer 24 and corresponding to the driving circuit region 20D, but the sealant 28 does not correspond to the signal transferring region 20C. In this situation, the sealant 28 overlaps the driving circuit 26 in the vertical direction, and the area of the peripheral region 20P in the first substrate 20 may be reduced.

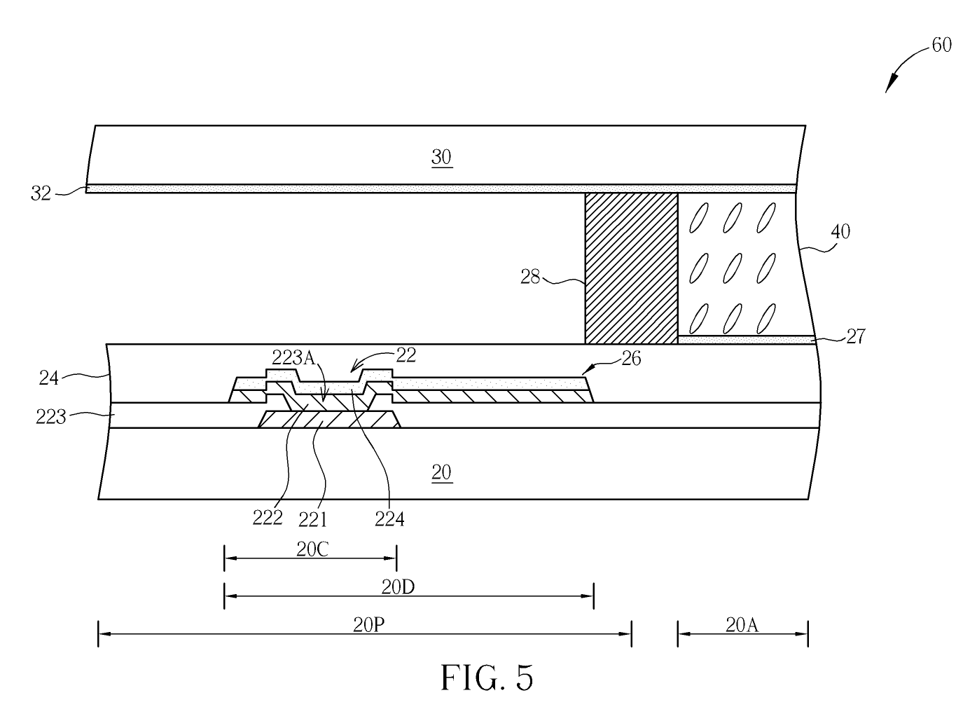

Please refer to FIG. 5. FIG. 5 is a schematic diagram illustrating a cross-sectional view of a display panel according to a third preferred embodiment of the present invention. As shown in FIG. 5, in this embodiment, the sealant 28 of the display panel 60 is disposed on the passivation layer 24 and corresponding to a region between the driving circuit region 20D and the active region 20A, and the sealant 28 does not correspond to the signal transferring region 20C.

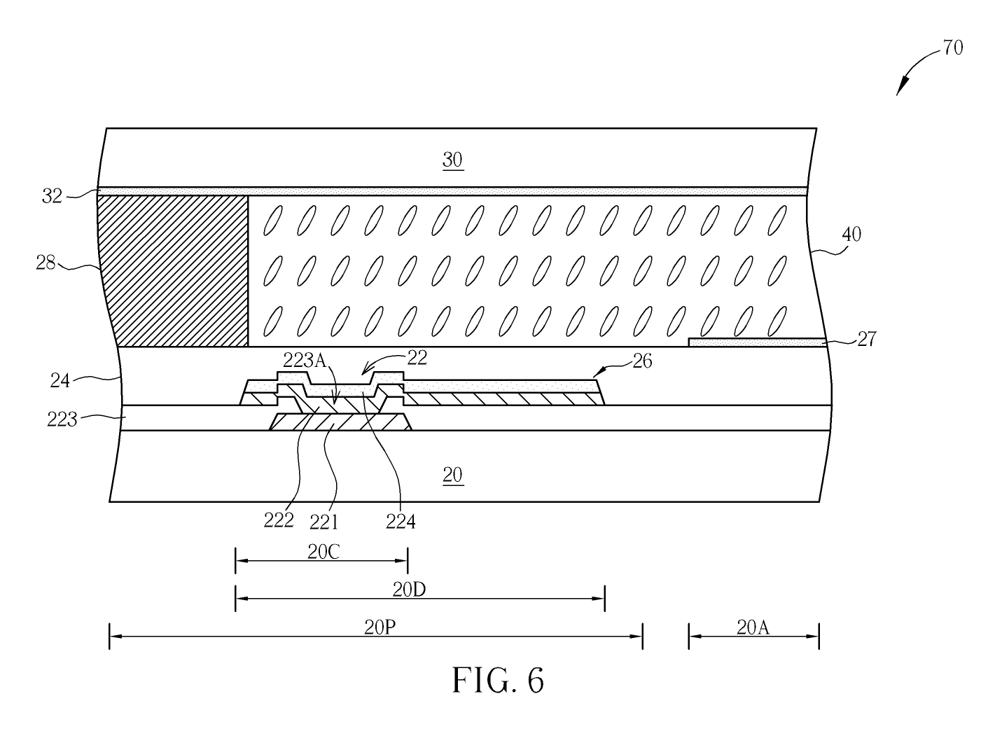

Please refer to FIG. 6. FIG. 6 is a schematic diagram illustrating a cross-sectional view of a display panel according to a fourth preferred embodiment of the present invention. As shown in FIG. 6, in this embodiment, the sealant 28 of the display panel 70 is disposed on the passivation layer 24 and corresponding to an outside region of the driving circuit region 20D comparative to the active region 20A, and the sealant 28 does not correspond to the signal transferring region 20C.

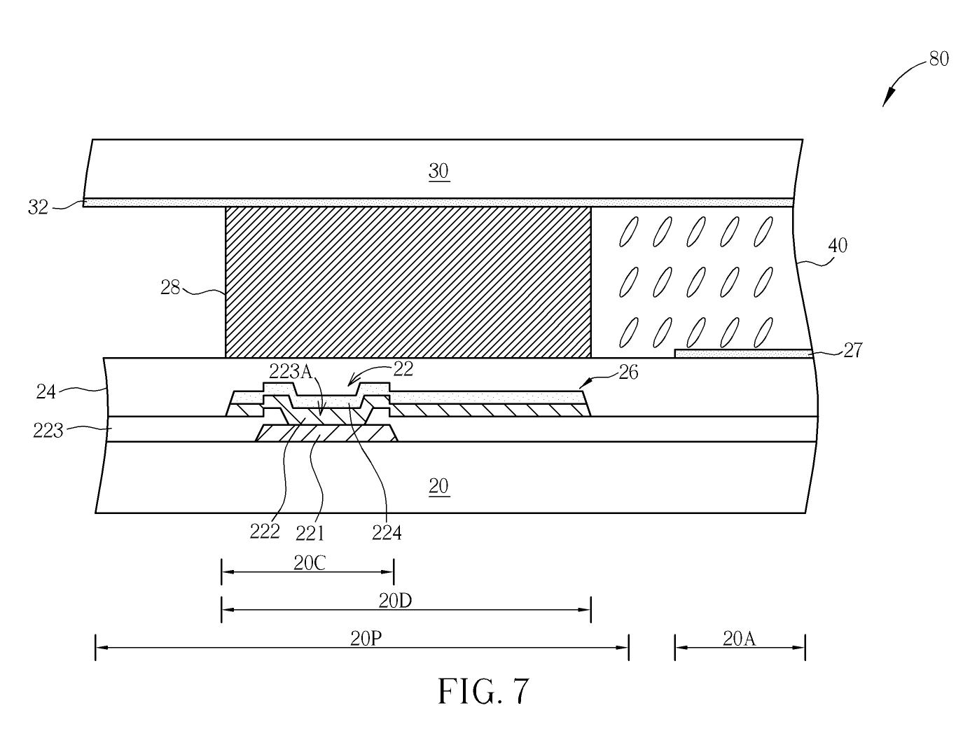

Please refer to FIG. 7. FIG. 7 is a schematic diagram illustrating a cross-sectional view of a display panel according to a fifth preferred embodiment of the present invention. As shown in FIG. 7, in this embodiment, the sealant 28 of the display panel 80 is disposed on the passivation layer 24, and the sealant 28 entirely covers the driving circuit region 20D. More specifically, the sealant 28 is disposed on the passivation layer 24 and the sealant 24 entirely covers the driving circuit region 20D and the signal transferring region 20C.

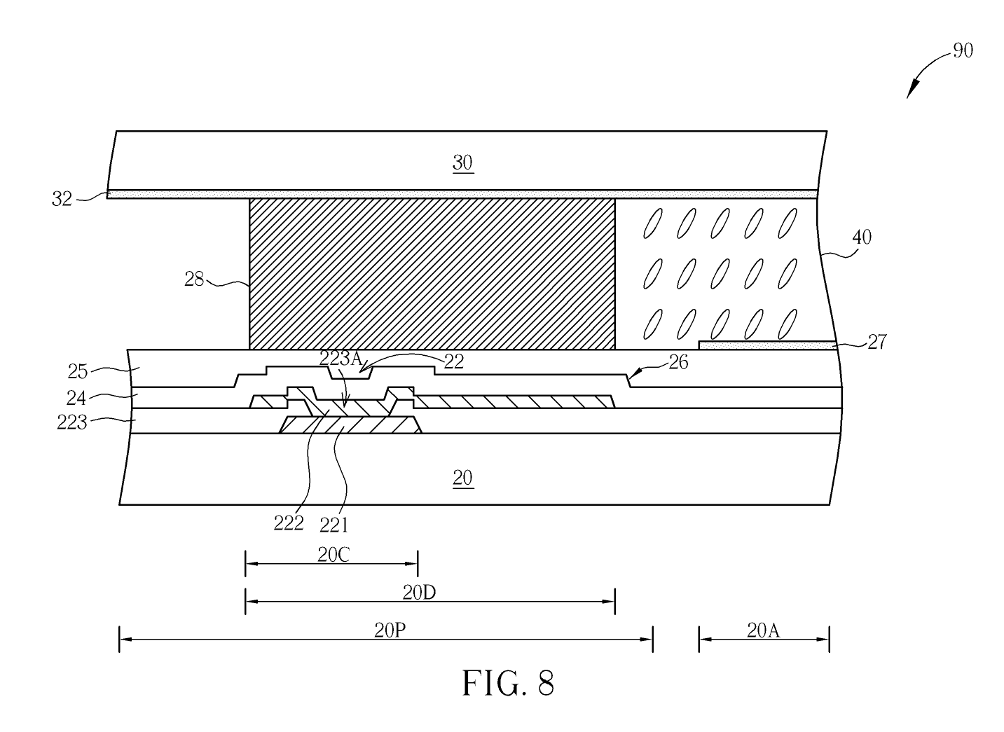

Please refer to FIG. 8. FIG. 8 is a schematic diagram illustrating a cross-sectional view of a display panel according to a sixth preferred embodiment of the present invention. As shown in FIG. 8, in this embodiment, the signal transferring structure 22 of the display panel 90 may comprise a first conductive layer 221, an insulating layer 223, and a second conductive layer 222. The second conductive layer 222 overlaps the first conductive layer 221, and more specifically, the second conductive layer 222 is disposed on the insulating layer 223 and electrically connected to the first conductive layer 221 through the via hole 223A of the insulating layer 223. Additionally, in this embodiment, the transparent conductive layer is not disposed in the signal transferring structure 22. In other words, the first conductive layer 221 and the second conductive layer 222 are electrically connected to each other directly, without being connected by the transparent conductive layer or other conductive layers. Furthermore, for enhancing the protective and insulating effects on the signal transferring structure 22, a planar layer 25 may further be disposed selectively on the passivation layer 24, wherein the planar layer 25 may be an organic planar layer, an inorganic planar layer, or an organic-inorganic composite-layered planar layer. It is worthy of note that the approach of disposing the planar layer 25 is not limited to this embodiment and may be employed in all embodiments of the present invention. Additionally, in this embodiment, the sealant 28 entirely covers the driving circuit region 20D and the signal transferring region 20C, but the present invention is not limited to this. For example, the position of the sealant 28 may be any one of the positions disclosed in the embodiments shown in FIGS. 3-6.

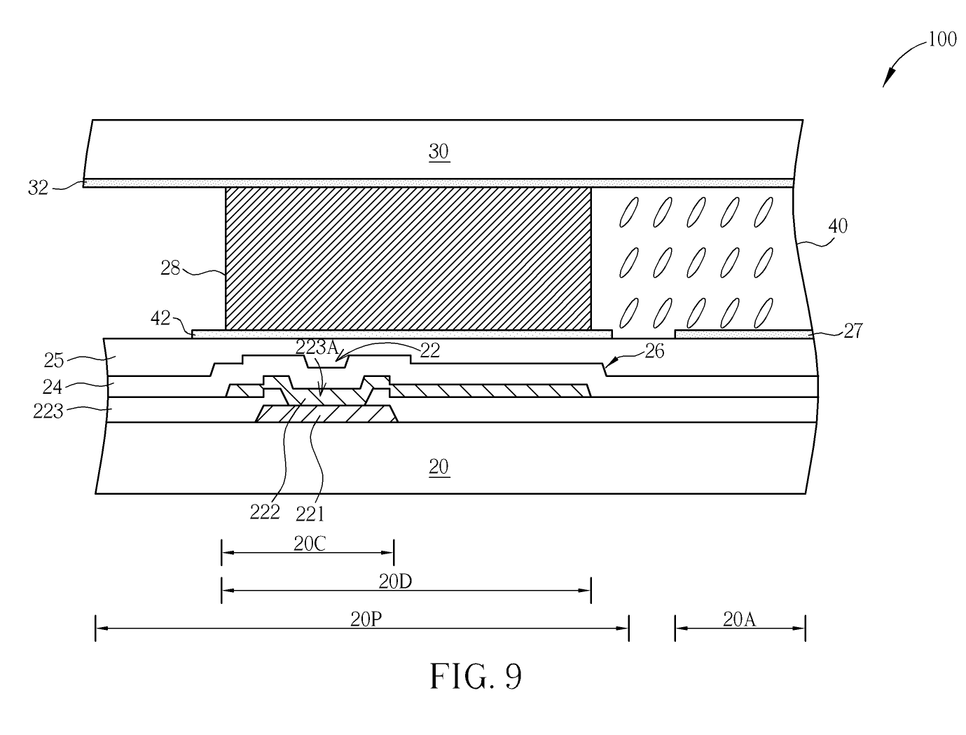

Please refer to FIG. 9. FIG. 9 is a schematic diagram illustrating a cross-sectional view of a display panel according to a seventh preferred embodiment of the present invention. As shown in FIG. 9, in this embodiment, the difference from the above-mentioned embodiments is that a transparent conductive layer 42 may be further disposed between the planar layer 25 and the sealant 28 of the display panel 100, wherein the transparent conductive layer 42 and the pixel electrode 27 may be made of the identical transparent conductive layer, but the present invention is not limited to this. The transparent conductive layer 42 may be used to electrically connect electrodes in an area of the driving circuit 26 other than that occupied by the signal transferring structure 22, but in this embodiment, the transparent conductive layer 42 corresponding to the position of the sealant 28 may be reserved.

To summarize the above description, in the display panel of the present invention, because the passivation layer of the display panel entirely covers the signal transferring structure, and the passivation layer may further entirely cover the driving circuit, distribution of the sealant will not be constrained by the signal transferring structure and the driving circuit. The distribution of the sealant may be modified as much as needed within the peripheral region of the first substrate, and narrow border design may be achieved by effectively reducing the area of the peripheral region. Additionally, because the dielectric constant of the sealant is less than the dielectric constant of the display media layer, the unnecessary coupling capacitance effect may be further reduced and the power consumption of the display panel may be reduced, too.

Those skilled in the art will readily observe that numerous modifications and alterations of the device and method may be made while retaining the teachings of the invention.

What is claimed is:

1. A display panel, comprising:
a first substrate comprising an active region and a peripheral region, the peripheral region comprising a driving circuit region, and the driving circuit region comprising a signal transferring region;
a second substrate, disposed oppositely to the first substrate;
a display media layer, disposed between the first substrate and the second substrate;
a signal transferring structure, disposed in the signal transferring region of the first substrate;
a passivation layer, disposed on the first substrate, and entirely covering at least the signal transferring structure; and
a sealant, disposed on the passivation layer for bonding the first substrate and the second substrate together.

2. The display panel of claim 1, wherein the display media layer has a first dielectric constant, the sealant has a second dielectric constant, and the second dielectric constant is less than the first dielectric constant.

3. The display panel of claim 2, wherein the first dielectric constant is substantially greater than 5, and the second dielectric constant is substantially less than 5.

4. The display panel of claim 3, wherein the first dielectric constant is substantially between 7 and 10, and the second dielectric constant is substantially between 3 and 5.

5. The display panel of claim 1, wherein the sealant is disposed on the passivation layer and the sealant corresponds at least to the signal transferring region.

6. The display panel of claim 1, wherein the sealant is disposed on the passivation layer and the sealant corresponds at least to the driving circuit region.

7. The display panel of claim 1, wherein the sealant is disposed on the passivation layer and the sealant does not correspond to the signal transferring region.

8. The display panel of claim 7, wherein the sealant is disposed on the passivation layer and the sealant corresponds to a region between the driving circuit region and the active region.

9. The display panel of claim 7, wherein the sealant is disposed on the passivation layer and the sealant corresponds to an outside region of the driving circuit region relative to the active region.

10. The display panel of claim 1, wherein the signal transferring structure comprises a first conductive layer and a second conductive layer, the second conductive layer overlaps the first conductive layer, and the second conductive layer is electrically connected to the first conductive layer.

11. The display panel of claim 10, wherein the signal transferring structure further comprises a transparent conductive layer, overlapping the second conductive layer and electrically connected to the second conductive layer.

12. The display panel of claim 1, wherein the passivation layer includes an inorganic passivation layer, an organic passivation layer, and an organic-inorganic composite-layered passivation layer.

13. The display panel of claim 1, wherein the sealant includes a conductive sealant.

14. The display panel of claim 1, wherein the display media layer includes a liquid crystal layer.

15. The display panel of claim 1, wherein the passivation layer entirely covers the driving circuit region.

16. The display panel of claim 1, further comprising a planar layer disposed between the passivation layer and the sealant.

17. The display panel of claim 1, further comprising a transparent conductive layer disposed between the passivation layer and the sealant.

18. A display panel, comprising:
a first substrate comprising an active region and a peripheral region, the peripheral region comprising a driving circuit region, and the driving circuit region comprising a signal transferring region;
a second substrate, disposed oppositely to the first substrate;
a display media layer, disposed between the first substrate and the second substrate;
a signal transferring structure, disposed in the signal transferring region of the first substrate and comprising:
a first conductive layer;
an insulating layer, disposed on the first conductive layer and comprising at least a via hole to expose a part of the first conductive layer; and
a second conductive layer, disposed on the insulating layer and electrically connected to the first conductive layer through the via hole;
a passivation layer, disposed on the first substrate, and entirely covering at least the signal transferring structure; and
a sealant, disposed on the passivation layer for bonding the first substrate and the second substrate together.

19. The display panel of claim 18, wherein the display media layer has a first dielectric constant, the sealant has a second dielectric constant, and the second dielectric constant is less than the first dielectric constant.

20. The display panel of claim 19, wherein the first dielectric constant is substantially greater than 5, and the second dielectric constant is substantially less than 5.

21. The display panel of claim 20, wherein the first dielectric constant is substantially between 7 and 10, and the second dielectric constant is substantially between 3 and 5.

22. The display panel of claim 18, wherein the sealant is disposed on the passivation layer and the sealant corresponds at least to the signal transferring region.

23. The display panel of claim 18, wherein the sealant is disposed on the passivation layer and the sealant corresponds at least to the driving circuit region.

24. The display panel of claim 18, wherein the sealant is disposed on the passivation layer and the sealant does not correspond to the signal transferring region.

25. The display panel of claim 24, wherein the sealant is disposed on the passivation layer and the sealant corresponds to a region between the driving circuit region and the active region.

26. The display panel of claim 24, wherein the sealant is disposed on the passivation layer and the sealant corresponds to an outside region of the driving circuit region relative to the active region.

27. The display panel of claim 18, wherein the signal transferring structure further comprises a transparent layer, overlapping the second conductive layer and electrically connected to the second conductive layer.

28. The display panel of claim 18, wherein the passivation layer includes an inorganic passivation layer, an organic passivation layer, and an organic-inorganic composite-layered passivation layer.

29. The display panel of claim 18, wherein the sealant includes a conductive sealant.

30. The display panel of claim 18, wherein the display media layer includes a liquid crystal layer.

31. The display panel of claim 18, wherein the passivation layer entirely covers the driving circuit region.

32. The display panel of claim 18, further comprising a planar layer disposed between the passivation layer and the sealant.

33. The display panel of claim 18, further comprising a transparent conductive layer disposed between the passivation layer and the sealant.
